(19) United States
(12) Patent Application Publication
(10) Pub. No.: US 2003/0127872 A1
(43) Pub. Date: Jul. 10, 2003

(54) Clamping element for flat work pieces

(75) Inventors: Eugen Mannhart, (US); Reto Schubiger, (US)

Correspondence Address: David B. Ritchie, Thelen Reid & Priest LLP, P.O. Box 640640, San Jose, CA, 95164-0640, US

(73) Assignee: ESEC Trading SA, a Swiss Corporation

(21) Appl. No.: 10/338,609

(22) Filed: Jan. 7, 2003

(30) Foreign Application Priority Data
Jan. 9, 2002 (CH) 2002 0033/02

(51) Int. Cl. B25J 19/02

(52) U.S. Cl. 294/106; 294/907; 901/47

(57) ABSTRACT

A clamping element for a flat work piece, with a first clamping jaw with a first clamping surface and a second clamping jaw with a second clamping surface has an optical sensor for the measurement of the distance between the two clamping surfaces. The optical sensor is partially integrated into the clamping jaws. The optical sensor comprises an opto-transmitter, a first light guide and a second light guide and at least one photosensor. The first clamping jaw has a drill hole which accommodates an end of the first light guide and the second clamping jaw has a drill hole which accommodates an end of the second light guide.

### PRIORITY CLAIM

The present application claims priority under 35 U.S.C § 119 based upon Swiss Patent Application No. 2002 0033/02 filed on Jan. 09, 2002.

### FIELD OF THE INVENTION

A clamping element for clamping a flat work piece is known from the Swiss patent CH 679 878. A further development of such a clamping element is described in the Swiss patent CH 689 188.

With automatic assembly machines for the mounting and wiring of semiconductors, eg, with Die Bonders or Wire Bonders, such clamping elements are advantageously used for transporting the substrate. As a rule, the substrates are presented in magazines and supplied one after the other to the transport device of the automatic assembly machines. In doing so, it can happen that two substrates stick to each other and are therefore supplied together to the transport device and transported together by the clamping elements. In order to optimally protect high quality substrates from damage, a strip of paper or foil is often placed in the magazine between each two substrates. On supplying the substrate to the transport device, it can happen that the strip of paper or foil is supplied instead of the substrate or that the substrate is supplied together with the strip of paper or foil.

The object of the invention is to develop a sensor in order to enable reliable and timely detection of errors of this type.

### BRIEF DESCRIPTION OF THE INVENTION

The invention consists of providing a clamping element of the transport device with an optical sensor the output signal of which is proportional to the distance between the clamping surfaces of the clamping element. In accordance with a preferred version, the optical sensor comprises an opto-transmitter, a first light guide and a second light guide and at least one photosensor serving as opto-receiver. The clamping element has two clamping jaws. The first clamping jaw has a drill hole which accommodates one end of the first light guide and the second clamping jaw has a drill hole which accommodates the second light guide. Each of the two clamping jaws therefore accommodates one part of the optical sensor. The first light guide guides a light beam from the opto-transmitter to the second light guide which guides the incident light to the opto-receiver. The angle of incidence at which the light beam impinges on the second light guide is dependent on the aperture angle of the clamping jaws and therefore on the thickness of the clamped object. The portion of light which impinges on the second light guide changes with the angle of incidence so that the light intensity measured by the opto-receiver is a gauge for the thickness of the clamped object.

In accordance with a further version, the two light guides are omitted: The opto-transmitter and the opto-receiver are directly integrated into the clamping jaws.

### BRIEF DESCRIPTION OF THE DRAWING FIGURES

The accompanying drawings, which are incorporated into and constitute a part of this specification, illustrate three embodiments of the present invention and, together with the detailed description, serve to explain the principles and implementations of the invention. The figures are not to scale.

FIG. 1 shows a side view of a first embodiment of a clamping element in accordance with the invention,

FIG. 2 shows a plan view of a second embodiment of a clamping element in accordance with the invention, and

FIG. 3 shows a side view of a third embodiment of a clamping element in accordance with the invention.

### DETAILED DESCRIPTION OF THE INVENTION

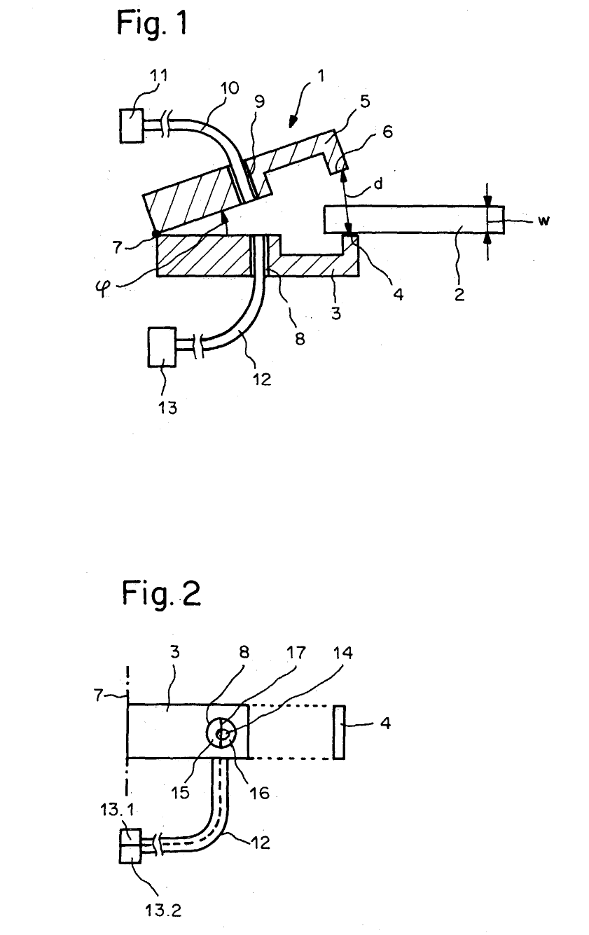

FIG. 1 shows schematically a side view of a first embodiment of a clamping element 1 for holding a flat work piece, eg, a substrate 2 in the form of a leadframe or BGA®, etc. The clamping element 1 has a first clamping jaw 3 with a first clamping surface 4 and a second clamping jaw 5 with a second clamping surface 6. The two clamping surfaces 4 and 6 lie opposite each other. The first clamping jaw 3 is rigidly arranged. The second clamping jaw 5 is rotatable on a horizontal axis 7. For clamping, it is actuated, for example by means of an electric, pneumatic or hydraulic drive, against the force of a return spring. The angle φ between the two clamping jaws 3 and 5 is proportional to the distance d between the two clamping surfaces 4 and 6. Therefore, when the substrate 2 is clamped between the two clamping jaws 3 and 5, then the angle φ is proportional to the thickness W of the substrate 2.

Each of the two clamping jaws 3 and 5 has a drill hole 8 or 9 which, in the closed condition of the clamping element 1 and as long as no substrate is clamped, run concentrically. The drill hole 9 accommodates the end of a first light guide 10 which is supplied with light from an opto-transmitter 11, for example a light-emitting diode or a an injection laser diode. The drill hole 8 accommodates the end of a second light guide 12 which guides the light impinging on the front face of this end of the light guide 12 to a photosensor 13. The two light guides 10 and 12 are typically round and their diameter amounts typically to 0.1 mm or less.

When the two clamping surfaces 4 and 6 touch, the light beam emitted by the first light guide 10 impinges vertically and therefore completely on the second light guide 12. When however the angle φ does not vanish because the clamping jaws 3 and 5 clamp the substrate 2, then the light beam emitted by the first light guide 10 impinges diagonally at the angle φ and therefore only partially on the second light guide 12 while the remaining portion impinges on the surface of the clamping jaw 3 surrounding the second light guide 12. The portion of the light beam impinging on the second light guide 12 is at a maximum when the angle φ is equal to zero and continuously reduces with increasing angle φ and therefore with increasing distance d between the two clamping surfaces 4 and 6. As a function of the distance d between the two clamping surfaces 4 and 6, the signal U of the photosensor 13 is thereby a monotonously descending function.

With a second embodiment, the second light guide 12 comprises two optical fibres 15 and 16 (or two fibre bundles) which guide the impinging light to two photosensors 13.1 and 13.2. This embodiment has the same construction as the first embodiment presented in FIG. 1. Details which differ from this are explained based on FIG. 2. FIG. 2 shows a plan view of the clamping jaw 3 and the second light guide 12 as well as the surface 14 illuminated by the light beam at a specific value φ₁ of the angle φ. The dividing line 17 between the two optical fibres 15 and 16 runs almost parallel to the rotational axis 7 of the second clamping jaw 5 (FIG. 1). The diameter of the second light guide 12 is greater than the diameter of the first light guide 10. Starting from the angle φ=0 where, because of the concentric arrangement of the two drill holes 8 and 9 (FIG. 1), both optical fibres 15 and 16 have roughly the same strength of illumination, the first optical fibre 15 is less strongly illuminated with increasing angle φ and the second optical fibre 16 is more strongly illuminated with increasing angle φ. The difference between the output signals U₁ and U₂ delivered by the two photosensors 13.1 and 13.2 now serves as the signal U for determining the distance d between the two clamping surfaces 4 and 6:

U=U₂−U₁. (1)

In this case, as a function of the distance d between the two clamping surfaces 4 and 6, the signal U is a monotonously ascending function.

The opto-transmitter 11, the two light guides 10 and 12 and the photosensor 13 or the two photosensors 13.1 and 13.2 form an optical sensor for measuring the thickness of the object clamped between the clamping jaws 3 and 5. By means of calibration, the relationship between the signal U and the distance d between the clamping surfaces 4 and 6 can be determined and saved.

The sensitivity of the sensor can be increased and the influence of light from external sources can be reduced when the known lock-in technique is applied with which the light emitted by the opto-transmitter is modulated.

The clamping element described schematically up to now can be realised in various ways. For use in transporting flat substrates on a Die Bonder or Wire Bonder, a clamping element is particularly suitable which is constructed in accordance with the patent specifications CH 679 878 and CH 689 188 quoted in the introduction. A transport device equipped with such clamping elements is known from the European patent EP 330 831. For detecting whether the substrate is correctly supplied with this transport device, the first clamping element is equipped with the optical sensor in accordance with one of the two embodiments.

During operation of the automatic assembly machine, the signal U delivered by the photosensor 13 (FIG. 1) in the first embodiment or the signal U derived from the photosensors 13.1 and 13.2 (FIG. 2) according to the equation (1) in the second embodiment, is digitised and evaluated as soon as the clamping element 1 clamps a supplied substrate 2 for the first time. The evaluation checks whether the measured distance d corresponds to the expected thickness W of the substrate 2. If this is not the case, then the following possibilities exist:

A) A wrong substrate has been supplied.

B) Two substrates stuck together have been supplied.

C) A substrate and a strip of paper or foil have been supplied.

D) Only a strip of paper or foil has been supplied.

E) The clamping jaw 5 no longer closes. This is the case when the measured signal U is equal to the signal in the open condition of the clamping element 1. The cause could be a fault in the drive.

In the event that such a fault is detected, an alarm is produced or the transport device carries the object to the outlet without processing, ie, without die or wire bonding.

With increasing wear of the clamping jaws the signal U also changes in the closed condition of the clamping element 1 when no substrate is clamped. Therefore, wear of the clamping jaws can also be determined with periodical tests.

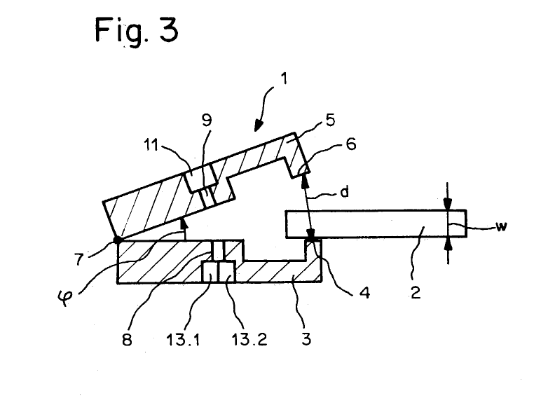

FIG. 3 shows schematically a side view of a third embodiment of the clamping element 1 with which the light guides are omitted. The drill holes 8 and 9 are widened on the side facing away from the clamping surface: The drill hole 9 accommodates the opto-transmitter 11, the drill hole 8 accommodates either one single photosensor 13 or two photosensors 13.1 and 13.2. If two photosensors are present, the dividing line between them runs analogously to the second embodiment so that the difference between the output signals U₁ and U₂ delivered by the two photosensors 13.1 and 13.2 according to the equation (1) can again be used as signal U for determining the distance d between the two clamping surfaces 4 and 6. The tapered sides of the drill holes 8 and 9 facing towards the clamping surfaces 4 or 6 have the task of guiding and bundling the light in a similar way as is done by the light guides with the other embodiments.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims and their equivalents.

What is claimed is:

1. A clamping element for a flat work piece, comprising:
a first clamping jaw having a first clamping surface;
a second clamping jaw having a second clamping surface, and
an optical sensor for measuring a distance between the two clamping surfaces wherein each clamping jaw accommodates a part of the optical sensor.

2. The clamping element according to claim 1, the optical sensor comprising:
a first light guide,
an opto-transmitter for supplying light to the first light guide,
a second light guide, and
at least a first photosensor for measuring an intensity of the light guided through the second light guide,
wherein the first clamping jaw has a drill hole accommodating an end of the second light guide and the second clamping jaw has a drill hole accommodating an end of the first light guide.

3. The clamping element according to claim 2, wherein the second light guide comprises a first and a second optical fibre, wherein the first optical fibre guides impinging light to the first photosensor and the second optical fibre guides impinging light to a second photosensor.

4. The clamping element according to claim 1, the optical sensor comprising an opto-transmitter and at least one photosensor, the first clamping jaw having a drill hole which accommodates the at least one photosensor and the second clamping jaw having a drill hole which accommodates the opto-transmitter.

5. The clamping element according to claim 4, wherein the drill hole in the first clamping jaw is tapered on the side facing towards the first clamping surface.

6. The clamping element according to claim 4, wherein the drill hole in the second clamping jaw is tapered on the side facing towards the second clamping surface.

7. The clamping element according to claim 5, wherein the drill hole in the second clamping jaw is tapered on the side facing towards the second clamping surface.
